(19) United States
(12) Patent Application Publication
(10) Pub. No.: US 2005/0136881 A1
(43) Pub. Date: Jun. 23, 2005

(54) Thermal incoming call indicator

(76) Inventor: Chia-Hao Chang, Taipei (TW)

Correspondence Address: BIRCH STEWART KOLASCH & BIRCH, PO BOX 747, FALLS CHURCH, VA, 22040-0747, US

(21) Appl. No.: 10/739,153

(22) Filed: Dec. 19, 2003

(51) Int. Cl. H04B 1/16

(52) U.S. Cl. 455/343.1

(57) ABSTRACT

A thermal incoming call indicator has a heat generator connected to a microprocessor of a wireless communication device and a metal plate connected to the heat generator. When the wireless communication device detects an incoming call, the microprocessor commands the heat generator to heat the metal plate for informing a user of the incoming call.

### FIELD OF THE INVENTION

The present invention relates to a thermal incoming call indicator and, more particularly, to a thermal incoming call indicator making use of thermal variation to inform the user of a wireless communication device of an incoming call.

### BACKGROUND OF THE INVENTION

Mobile networks will bring about various new applications and services as well as unlimited business opportunities. These applications and services integrate different information transmissions such as voice, data, the Internet and multimedia. Situational services provided by the mobile networks widely apply to every demand and function in life like entertainment, music, shopping, communications, travel and financial services.

For instance, when you walk on a road, a message from the mobile phone informs you that the day after tomorrow is your girlfriend's birthday. You can then use the mobile phone to search for nearby locations where you can buy a gift. After the mobile phone connects to the network and makes search, it shows that perfume is on sale at a department store. You can then use the mobile phone to search for a map and parking information of the department store, and can even use the mobile phone to buy perfume. This is known as a situational service, which combines site information, user's personal demands and complete information and electronic business services like online shopping and payment to provide a complete solution.

For travelers, the mobile networks provide really quick and real-time services. No matter where a traveler is, through the mobile positioning function, he can search for maps, weather, transportation schedules and restaurant locations, and can even make or cancel a reservation. Moreover, he can also watch a movie preview, buy a movie ticket and pay online. In addition to providing financial real-time information and online transactions, the mobile networks can also interactively complement lost history data when the mobile phone is off. Besides, thanks to mobile positioning technique, the driving safety of a car can also be enhanced. A driver can be found through signals sent out by his mobile phone for dealing with emergency situations.

Wireless communications will fully exploit communication efficiency and convenience and become basic demands of everyday lives. Especially for today's companies, one phone call may be a big business opportunity. Therefore, many businessmen can't turn off their mobile phones. However, this causes much trouble at a meeting. Common informing call rings or informing call vibrations trouble others or may even influence a speech or report.

### SUMMARY OF THE INVENTION

The primary object of the present invention is to provide a thermal incoming call indicator, in which a heat generator is connected to a microprocessor of a wireless communication device. When there is an incoming call, the microprocessor conducts current to the heat generator to cause temperature variation for informing a user of the wireless communication device of the incoming call.

Another object of the present invention is to provide a thermal incoming call indicator, which makes use of a heat generator to heat a metal plate to cause temperature variation for informing a user of a wireless communication device of the incoming call. Moreover, the temperature of the heat generator can be set to rise or drop according to different specific heats of materials to respond to different seasons or places.

To achieve the above objects, the present invention provides a thermal incoming call indicator, in which a heat generator is connected to a microprocessor of a wireless communication device. When there is an incoming call, the microprocessor conducts current to the heat generator to heat a metal plate for causing temperature variation. Once a user of the wireless communication device touches the metal plate, the user knows there is an incoming call. In this way, others are not bothered when there is an incoming call to the user.

### BRIEF DESCRIPTION OF THE DRAWINGS

The various objects and advantages of the present invention will be more readily understood from the following detailed description when read in conjunction with the appended drawing, in which:

FIG. 1 is a structure block diagram of a preferred embodiment of the present invention;

FIG. 2 is a structure diagram of a preferred embodiment of the present invention;

FIG. 3 is a diagram of another preferred embodiment of the present invention; and

FIG. 4 is a flowchart of a preferred embodiment of the present invention.

### DETAILED DESCRIPTION OF THE PREFERRED EMBODIMENTS

In order to solve the problem of bothering others due to conventional incoming call rings or incoming call vibrations, the present invention discloses a thermal incoming call indicator to inform a user of a wireless communication device of an incoming call in a soundless way.

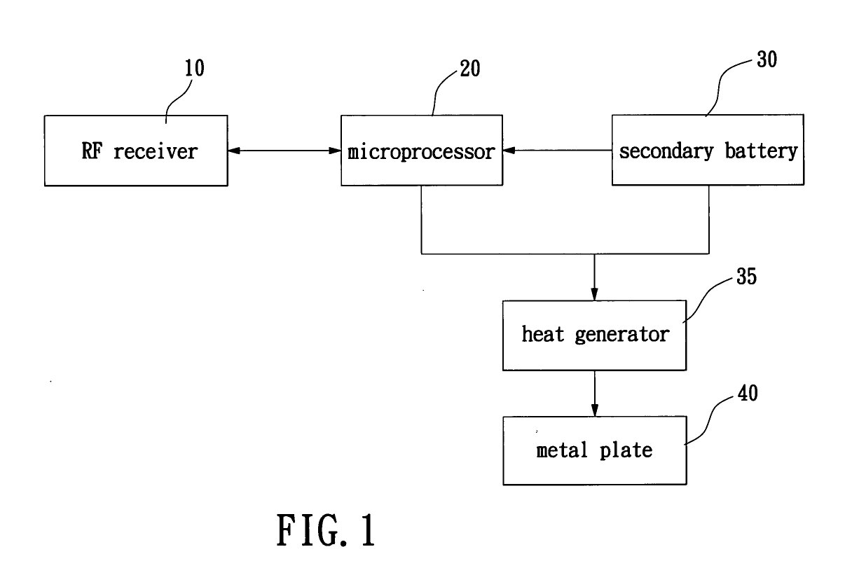

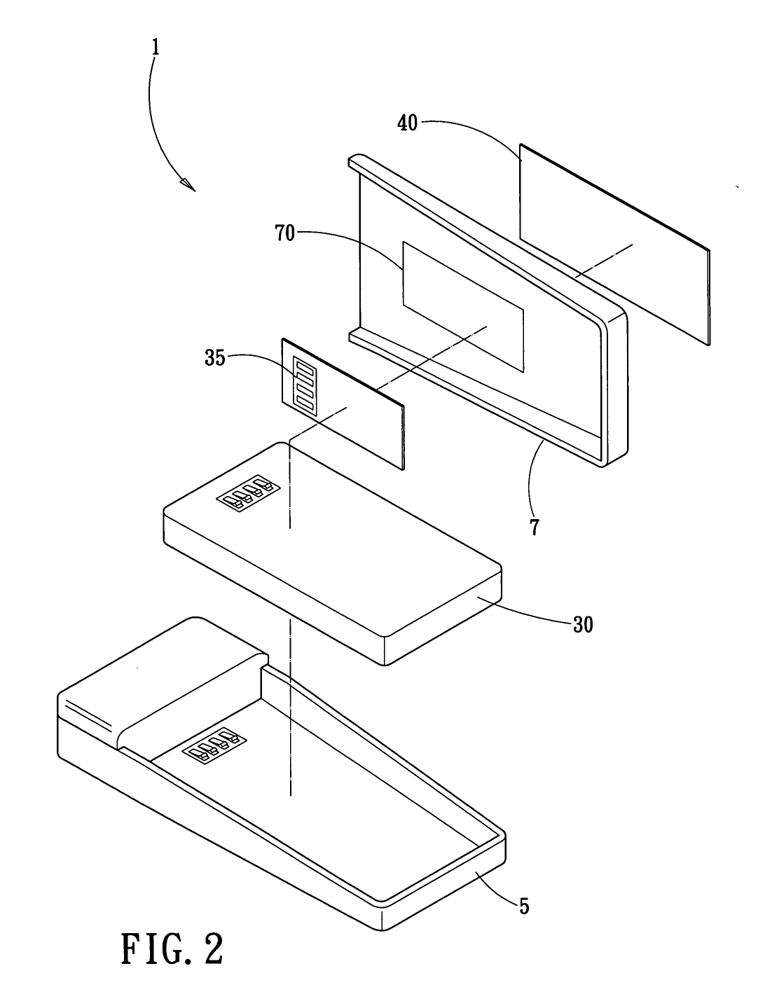

As shown in FIGS. 1 and 2, a thermal incoming call indicator comprises a wireless communication device 1, a heat generator 35 and a metal plate 40. The wireless communication device 1 includes a shell 5, a microprocessor 20 placed in the shell 5 and a secondary battery 30 placed n the shell 5. The heat generator 35 is connected to the microprocessor 20 and the secondary battery 30. The metal plate 40 is connected to the heat generator 35, and is placed in a hollowed-out place 70 of a battery cover 7. The heat generator 35 can be a thermoelectric cooler capable of cooling or heating through current or a heating wire or sheet.

When an RF receiver 10 receives a message, the microprocessor allows the secondary battery in the wireless communication device to connect to the heat generator. When the current of the secondary battery flows to the heat generator, the heat generator conducts heat or cold to the metal plate to cause a temperature variation. When a user of the wireless communication device contacts the metal plate, the user knows due to temperature variation that there is an incoming call. Moreover, the temperature variation can be set by the user.

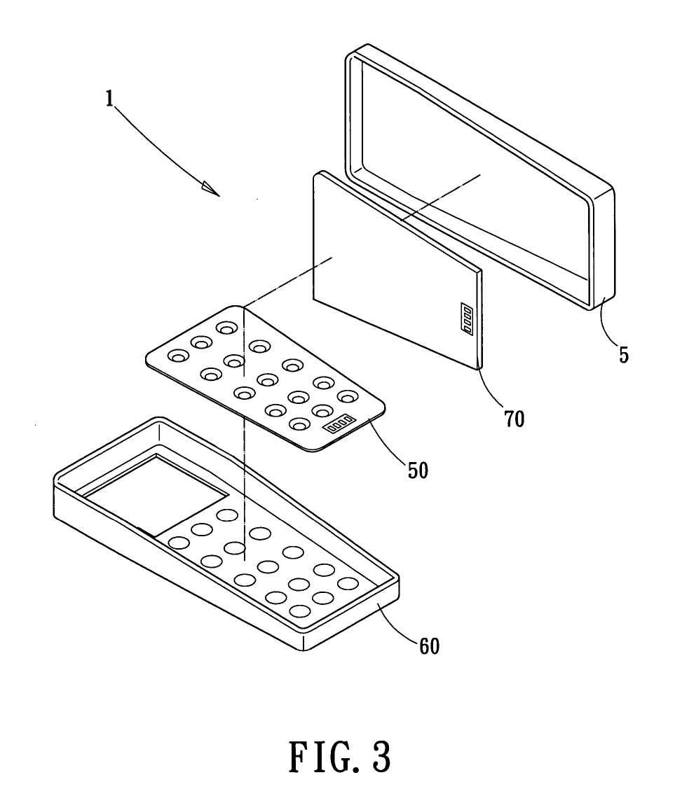

As shown in FIG. 3, in addition to being placed behind the secondary battery 30 and connected to the heat generator 35, the metal plate 40 can also be manufactured into a button board 50 placed between a panel 60 and a circuit board 70. The microprocessor 20 conducts the current of the secondary battery 30 to the button board 50, which then sends out the temperature variation via the panel 60. In the present invention, the current of the secondary battery 30 is conducted to the heat generator 35, which then conducts heat to the metal plate 40 or the button board 50 made of the metal plate to cause a temperature variation for informing the user of the wireless communication device of an incoming call.

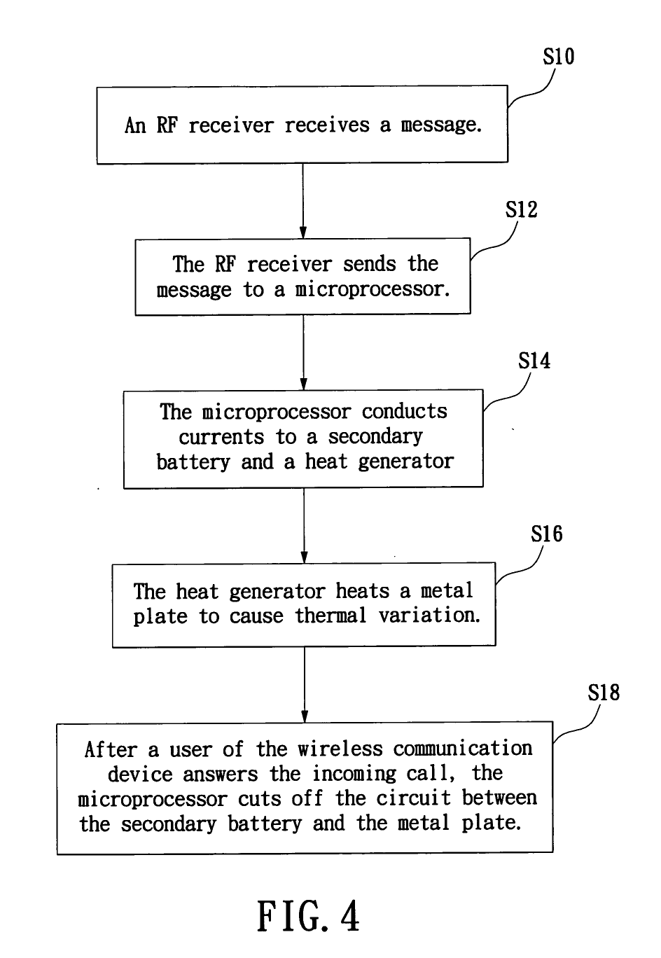

FIG. 4 is a flowchart of a preferred embodiment of the present invention. The flowchart comprises the following steps.

Step S10: An RF receiver receives a message.

Step S12: The RF receiver sends the message to a microprocessor.

Step S14: The microprocessor conducts currents to a secondary battery and a heat generator.

Step S16: The heat generator heats a metal plate to cause thermal variation.

Step S18: After a user of the wireless communication device answers the incoming call, the microprocessor cuts off the circuit between the secondary battery and the metal plate.

To sum up, the present invention discloses a thermal incoming call indicator, in which a metal plate is connected to a microprocessor of a wireless communication device. When the wireless communication device receives an incoming call, the microprocessor connects a heat generator and a secondary battery. When a current flows into the heat generator, a temperature variation is generated according to the specific heat of the material of the heat generator. The temperature variation is transmitted to the metal plate. When a user contacts the metal plate, the user knows that there is an incoming call. In this way, the present invention can solve the problem of bothering others due to conventional incoming call rings or incoming call vibrations, especially at a meeting.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

1. A thermal incoming call indicator comprises:
a shell;
a microprocessor placed in said shell;
a secondary battery placed in said shell;
a heat generator connected to said microprocessor and said secondary battery; and
a metal plate;
whereby when said microprocessor receives an incoming call, said microprocessor commands said secondary battery to provide electricity for said heat generator to inform a user of a wireless communication device of the incoming call through a temperature variation of said metal plate.

2. The thermal incoming call indicator as claimed in claim 1, wherein said microprocessor controls the current provided for said metal plate according to a temperature value set by the user.

3. The thermal incoming call indicator as claimed in claim 1, wherein said heat generator and said metal plate are placed behind said shell.

4. The thermal incoming call indicator as claimed in claim 1, wherein said metal plate is a button board of said shell.

5. The thermal incoming call indicator as claimed in claim 1, wherein said heat generator is a metal capable of generating heat through a current.

6. The thermal incoming call indicator as claimed in claim 1, wherein said heat generator is a thermoelectric cooler capable of cooling or heating through a current.
